(19) United States
(12) Patent Application Publication
(10) Pub. No.: US 2021/0240478 A1
(43) Pub. Date: Aug. 5, 2021

(54) SYSTEM AND METHOD FOR GENERATING DATA-FLOW ANALYSIS PIPELINES

(71) Applicant: TECHNION RESEARCH & DEVELOPMENT FOUNDATION LIMITED, Haifa (IL)

(72) Inventor: Roy KISHONY, Haifa (IL)

(21) Appl. No.: 17/167,750

(22) Filed: Feb. 4, 2021

Related U.S. Application Data
(60) Provisional application No. 62/969,771, filed on Feb. 4, 2020.
(60) Provisional application No. 63/072,304, filed on Aug. 31, 2020.

(51) Int. Cl. G06F 9/38; G06F 9/30

(52) U.S. Cl. CPC G06F 9/3812; G06F 9/3836; G06F 9/3005

(57) ABSTRACT

A method of generating analysis pipelines in a network of a plurality of objects comprises receiving, via a user interface, an intervening input that overrides an existing input or the result of one or more functional transformations. The method recursively propagates the intervening input to upstream objects by inverting object functions and propagating the intervening overriding downstream to dependent objects to indicate which downstream functional transformations, or portions thereof, are invalidated.

### FIELD OF THE INVENTION

The present invention relates generally to the framework of dataflow computations. More specifically, the present invention relates to a method and system for interactive, traceable and computationally efficient dataflow analysis.

### BACKGROUND OF THE INVENTION

Traceability, interactivity, transparency and efficiency are becoming increasingly important in the data analysis pipelines (computer code that transform data) underlying today's data-rich science research and engineering. These analysis pipelines are typically composed of multiple steps, where raw data is hierarchically transformed into simpler, and gradually more insightful, data forms. Notably, these pipelines are rarely fully automated; they require multiple human decisions, interventions and continuous tuning of parameters along each of their many steps (e.g., choosing thresholds, defining averaging windows, excluding data points, cleaning artifacts, etc.).

However, to date, there is no simple way to incorporate, follow, document and expose such manual decisions. There is also no easy way to propagate such changes both downstream and upstream in the computational network. It is typically very difficult to trace backward from a focal result to the set of raw data sources and the many manual parameters and decisions that affected it. Furthermore, once parameters are changed, it is difficult to know which downstream calculations, or portions thereof, are affected and what specific parts of the pipeline and data items must be re-calculated.

### SUMMARY OF THE INVENTION

A computational network as disclosed and described herein below may comprise a plurality of functional objects, adapted to perform a functional transformation of one or more input data objects and to produce an output data object. Input or output data object may comprise, each, plurality of sub-sets of data elements denoted sub-elements. According to some embodiments of the present invention a user may be able to override the output data object of a given functional object either as whole or by overriding a sub-set of data elements of the output data object.

A method of generating analysis pipelines in a network of a plurality of connected objects is disclosed, wherein in the following description each object is either a “data object” (any data structure, where data-objects can also be composed of a set of “data elements”) or is a “functional object” that is configured to produce an output data-object by performing a functional transformation on inputs it receives from the outputs of upstream functional objects as well as on other data sources (files, numerical values, graphics, etc.). Functional objects may cache their output data objects, or specific subset of elements thereof, to reduce calculation time in repeated runs. The method may comprise receiving, via a user interface, an intervening input overriding any of the data objects, or overriding the output result of one or more of the functional objects. Such intervening can either override an object as a whole or overriding specific sub-sets of its output data elements. The method may further comprise recursively propagating such intervening input to upstream objects by inverting the function of functional objects, either as a whole or for sub-set of their data elements. Once an intervention is made, the method may further comprise propagating the intervening overriding to downstream dependent functional objects to indicate which downstream functional transformations and cached outputs, or specific sub-sets thereof, are invalidated.

A method of generating data analysis pipelines in a network of a plurality of objects is disclosed, wherein each object represents one of a functional object adapted to produce an output data object by performing transformation of its inputs, the method comprising receiving, via a user interface, an intervening input overriding at least one from a list comprising existing data object and the output data object of any of the functional objects, recursively propagating the intervening input to upstream objects by inverting functions of functional objects and propagating the intervening overriding downstream to dependent objects to indicate which downstream functional transformations are invalidated by the overriding input.

In some embodiments the input data object to each functional object is one or more from a list comprising files, numerical input data, and output data objects of one or more upstream functional objects of the plurality of objects in the network.

In some embodiments the inverting of functional object is done by one or more of automatically choosing which upstream object to override and manually choosing which upstream object to override.

In some embodiments the method further comprising a step of recalculating the downstream functional transformations that were indicated invalid.

In some embodiments the inverting of the object functions is done by connecting specific sub-elements of an output data object with corresponding specific sub-elements of its respective input data objects.

A computing device is disclosed comprising a controller, a memory unit, a storage unit, an input unit and an output unit wherein, the storage unit comprises executable code that when loaded to the memory unit and executed by the controller, is configured to perform receiving, via a user interface, an intervening input overriding at least one from a list comprising existing input data object and the output data object of any of the functional objects, recursively propagating, by the controller, the intervening input to upstream objects by inverting functions of functional objects and propagating, by the controller, the intervening overriding downstream to dependent objects to indicate which downstream functional transformations are invalidated by the overriding input.

A method of generating analysis pipelines in a network of a plurality of objects is disclosed, wherein each object represents one a functional object adapted to perform transformation of its inputs or an output data object produced by the functional transformation, the method comprising receiving, via a user interface, an intervening input overriding a subset of the data elements of the output data object of any of the functional objects, recursively propagating, by the controller, the intervening input upstream to respective subset of data objects by inverting functions of functional objects and propagating the intervening overriding downstream to dependent objects to indicate which downstream subsets of data elements of data objects are invalidated by the overriding input.

In some embodiments the input data object to each functional object is one or more from a list comprising files, numerical input data objects, and output data objects of one or more upstream objects of the plurality of objects in the network.

In some embodiments the inverting of functional objects is done by one or more of automatically choosing which upstream object to override and manually choosing which upstream object to override.

In some embodiments the method further comprising recalculating the downstream functional transformations of the subsets of data elements of data objects that were indicated invalid.

In some embodiments the inverting of the object functions is done by connecting specific sub-elements of an output data object with corresponding specific sub-elements of the respective input data object.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a high-level block diagram of an exemplary computing device according to embodiments of the present invention;

FIG. 2 is a graphical representation of several divergence forms of objects, according to embodiments of the present invention;

FIGS. 3A-3D depict a graphical representations of input divergence on output divergence for several example operations/functions, according to embodiments of the present invention;

FIG. 4 is a graphical representation of Inverse Assignment, according to some embodiments of the present invention;

FIG. 5 is a schematic representation of general graph illustrating element-specific Inverse Assignment in a multi-level, multi branches network, according to embodiments of the present invention; and

FIG. 6 is a schematic flow diagram depicting a method of affecting a user assigned value to an object in a multi-layer, multi-branch network according to embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Aspects of the present invention may be embodied as a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a LAN, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Python, Matlab, Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the described herein illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the following description of embodiments of the invention the term downstream data flow will refer to the direction of data flow and data processing and manipulating that begins with raw data or user numerical inputs, or input objects (e.g. data that was not yet processed) and flows through functional-objects towards desired processed output results. Similarly, the term upstream data flow will refer to the opposite direction of flow, from a processed result towards the raw data or user inputs. The term ‘assignment’, as used with respect to data or computational manipulations, will refer to intervention by a user in the automated data processing flow that assigns new value to an input object or that overrides the output of a functional-object, as a whole or at sub-set of data elements. The term ‘inverse assignment’ will refer to an automated process that propagates the impact resulting from an ‘assignment’ to an object to upstream objects, recursively.

In some embodiments, the present disclosure introduces a tool that provides interactivity, traceability, transparency and efficiency to high-level programming. Embodiments of the present invention provide a user a tool allowing downstream and upstream tracing between raw data and processed data. The present disclosure thereby enables a much-needed form of data analysis which is interactive and efficient, yet also inherently transparent, reproducible, and traceable.

In some embodiments, the present disclosure introduces automatic translating of programming scripts into a network of data-flow computational objects.

In some embodiments, the present disclosure introduces functional-objects that perform a function on their inputs to produce an output, either as a whole (converged objects) or individually for sub-set of data elements of their output data-object (diverged objects).

In some embodiments, objects can cache output results to save calculation time in repeated runs, either caching the whole output data object (converged objects), or independently caching sub-sets of data element (diverged objects).

In some embodiments, the calculated output of any functional-object, or specific sub-sets of its output data elements, can be easily overridden by a user either programmatically, manually, or interactively, and any such interventions may automatically be documented, for example in human readable/writable log files.

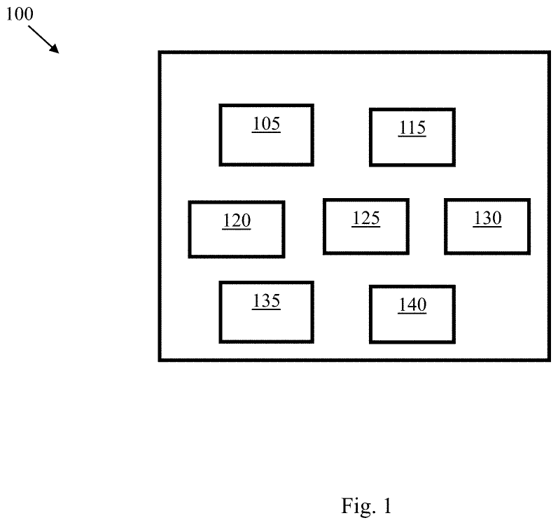

Reference is made to FIG. 1, showing a high-level block diagram of an exemplary computing device 100 according to embodiments of the present invention. Computing device 100 may include a controller 105 that may be, for example, a central processing unit processor (CPU), a chip or any suitable computing or computational device, an operating system 115, a memory unit 120, an executable code 125, a storage unit 130, input devices 135 and output devices 140. Controller 105 may be configured to carry out methods described herein, and/or to execute or act as dictated by the various modules, units, etc. More than one computing device 100 may be included in a system according to embodiments of the invention, and one or more computing devices 100 may act as the various components of a system. For example, by executing executable code 125, e.g. when stored in memory 120, controller 105 may be configured to carry out a method for generating analysis pipelines in a network of a plurality of objects.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or enabling software programs or other modules or units to communicate. Operating system 115 may be a commercial operating system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be an application that generates analysis pipelines in a network of a plurality of objects as further described herein. Although, for the sake of clarity, a single item of executable code 125 is shown in FIG. 1, a system according to embodiments of the invention may include a plurality of executable code segments similar to executable code 125 that may be loaded into memory 120 and cause controller 105 to carry out methods described herein. For example, units or modules described herein may be, or may include, controller 105 and executable code 125.

Storage 130 may be or may include, for example, a hard disk drive, a floppy disk drive, a Compact Disk (CD) drive, a CD-Recordable (CD-R) drive, solid state drive (SSD), solid state (SD) card, a Blu-ray disk (BD), a universal serial bus (USB) device or other suitable removable and/or fixed storage unit. Content may be stored in storage 130 and may be loaded from storage 130 into memory 120 where it may be processed by controller 105. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include sensors or other components, e.g., a camera, a microphone, a motion detector and the like. Other components that may be included in input devices 135 may be a mouse, a keyboard, a touch screen or pad or any suitable input device. It will be recognized that any suitable number of input devices may be operatively connected to computing device 100 as shown by block 135. Output devices 140 may include one or more displays or monitors, speakers and/or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105.

Some embodiments may be provided in a computer program product that may include a non-transitory machine-readable medium, stored thereon instructions, which may be used to program a computer, controller, or other programmable devices, to perform methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more devices such as computing device 100.

Science, biomedicine and engineering applications and the like often require the development and execution of specialized data analysis pipelines, where raw data (such as data containing images, genomics, biomedical data, finance data, etc.) is processed through multiple analysis layers, from annotation and cleaning through statistics and model fitting to visualization. The output of these data analysis pipelines can be used for computer-support decisions.

These pipelines are rarely fully automated: the examination of key steps and the manual specification of parameters and thresholds are an inherent and required part of analysis pipelines. Ultimately, therefore, any downstream insight or published figure or computer-assisted recommendation depends not only on the raw data, but also on the many manually specified parameters and interventions. Yet, there are currently no good tools for generating a pipeline that allows well-documented manual interventions while facilitating upstream traceability from any focal result to its underlying raw data and the many manual choices that affected it. It also typically difficult to tell which specific calculation steps, or even specific portions thereof, must be recalculated upon changes to specific parameters.

Accordingly, in some embodiments, the present disclosure provides for an automated tool which allows generating inter-connected data-flow objects (input objects and functional-objects) which chain data and computations while allowing interactive human override, and with automatic documentation of any such user overrides.

In some embodiments, the present disclosure defines objects that implement a network of dataflow objects. Each object is either an input-object or a functional-object that executes a specified internal function on a set of arguments to produce output. The arguments can include internal inputs, files as well as outputs of other objects and the output is a data-object that can include numeric data, files, or graphics. Complex analysis pipelines are formed by connecting multiple input and functional objects into a network where the output data-object of one or more objects serve as inputs for other objects.

In some embodiments, this network of objects may be defined using standard programming syntax. Any operation/command that involves objects as arguments may automatically yield a new object whose function is to perform the operation. For example, if S is an object, using the syntax C=cos(S) yields a new object C whose internal function is to apply the function cos to the output of S. This behavior is achieved by overloading all (or any) standard command and function of a programming language (e.g., Matlab, Python, R, etc.). Indexing, referencing and concatenation are also overloaded (for example, a Matlab statement like A=[B(end).age, B(1).age], can yield an object A whose internal function is to concatenate the field “age” from the last and first elements of B). User-defined functions, or calls to external libraries, are also facilitated as objects whose internal function is to call these user defined functions. It would be apparent to those of ordinary skill in the art that the term ‘overloading’ as used in this description is a known object-oriented terminology for re-specifying how otherwise known functions should behave when they act on one's object.

In some embodiments, while the output of each functional object is defined by its internal function and arguments (which could be data, files, graphics, or the output of other functional objects), a user can easily and readily override these outputs, or specific portions thereof. Overriding can be done interactively or programmatically, for example using simple normal-syntax assignments to the object. For example, if S is a functional object whose output is a boolean vector indicating whether each of N data object (e.g., genomes, financial records, etc.) has passed a quality validation function, then the statement S(5)=1 overrides the output in that specified position. Such user assignments can be stored as a log of manual interventions, documenting the time, the name of the user making the assignment and an optional comment indicating the reason for overriding.

In some embodiments, the assignment log for each object is stored in a simple human-machine readable/writable text files (for example CSV). These files provide the traced list of human interventions: changes to these files (e.g. CSV files documenting human interventions) are automatically detected by their corresponding objects and incorporated as object overrides in real-time. The user can, therefore, make assignments either from the command line, a script, a GUI (see below), or by changing the assignment log file, and any such change is automatically recorded and documented. This implementation also allows Undo/Redo and a “time-machine” functionality, whereby the user specifies a specific date and time and all objects return to the input they had at that specified time.

In some embodiments, the present disclosure provides for caching object outputs, tracking cache validity and re-evaluating object function specifically upon demand. Once calculated, object outputs may be cached in computer memory to reduce calculation time in future calls. When a user-defined input to an object changes, the object cache may automatically be marked as invalid and the object may recursively notify any downstream objects that their respective cached outputs are no longer valid (“change cascade”). When a given object is asked for its output, the requested output may either be retrieved from the cache or may be recalculated it if invalid. When an object recalculates its output, it asks for the output of respective upstream objects that serve as its arguments/inputs, recursively.

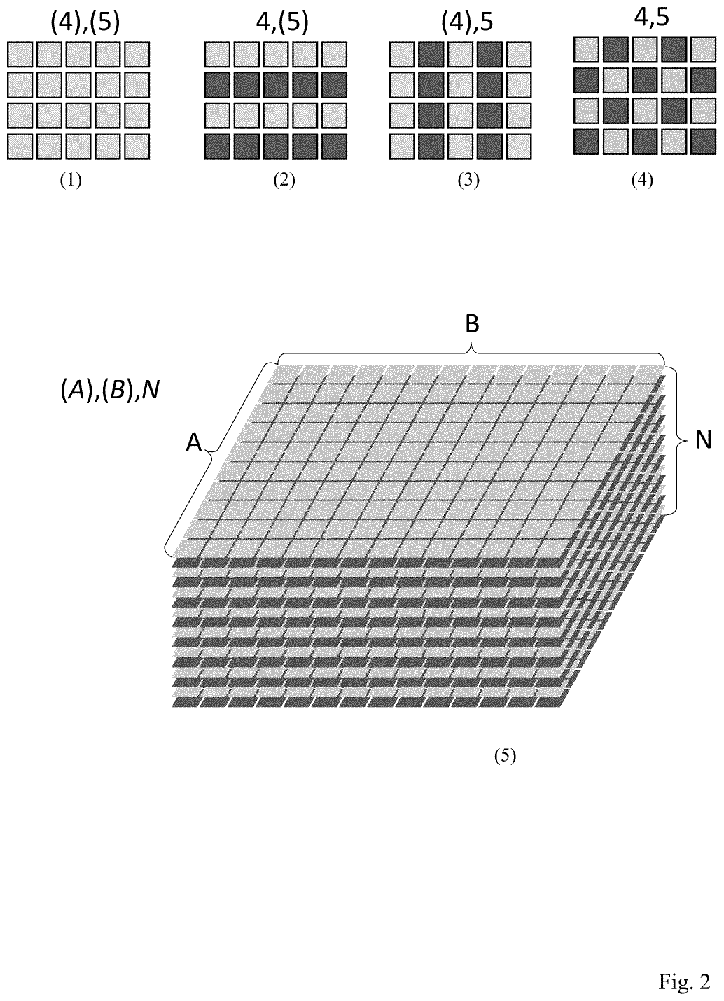

In some embodiments, object outputs can be computed, cached and tracked for cache-validity as a whole or as sub-elements. When the output of an object is an array, one way to specify whether the output of an object is calculated as a whole or as sub-elements, is to specify for each dimension of the array whether it should be processed in “Diverged” or “Converged” mode, herein after “divergence state” (see FIG. 2 below). Consider, for example, a functional object S that performs a computationally-heavy image analysis function on each image in an array of N images each of size W×L (an array of W×L×N, see in FIG. 2 (5) below). If the 3rd dimension N of its input is specified as Diverged, then each image is separately calculated, stored in cache, and tracked for cache validity. Namely, when a single image upstream changes, only the cached results of the analysis of this specific image is invalidated while the cached results of all other images remain valid.

Reference is made to FIG. 2, which is a graphical representation of several divergence forms of objects, according to embodiments of the present invention. FIG. 2 represents a converged two-dimensional array (1), a two-dimensional array where the rows are diverged and the columns are converged (2), a two-dimensional array where the columns are diverged and the rows are converged (3) a two-dimensional array where both the rows and columns are diverged (4), and a three-dimensional array converged in the first and second dimensions (A, B), but diverged in the third dimension (N). The separation of these arrays designates sub-sets of data-elements of the array that are independently computed, cached and tracked for cache validity/invalidity. In all of these examples, a notation is used to indicate array size with diverged and converged dimensions, where converged dimension sizes are indicated in parentheses. For example, an array of size “4,(5)” is diverged in the first dimension and converged in the second dimension.

By default, the diverged status of an object is propagated to any downstream objects that depends on it: if the downstream calculation can be done separately on a diverged sub-set of the data-elements of its input, then its output will also be diverged. For example, in the example of the stack of images above (S is an array of size W×L×N, converged in 1^{st} and 2^{nd} dimensions and diverged in the 3^{rd} dimension), a statement like mS12=mean(S, [1 2]) (an example using Matlab syntax specifying averaging array S along the first and second dimensions) will produce an object mS12 which is also diverged in the 3^{rd} dimension (because the operation can be done on each sub-Object independently). In contrast, the operation mS3=mean(S, 3) (an example Matlab syntax for specifying averaging array S along the third dimension) will produce an object mS3 which is converged in all dimensions (because the operation cannot be performed on each portion of the output of S independently). In general, the implementation of any function is coded such that it preserves the divergence of its sources as possible. Objects may automatically diverge along a given dimension D if changes to specific diverged slices of their input arrays are guaranteed to affect only specific slices of their output in this specific dimension D.

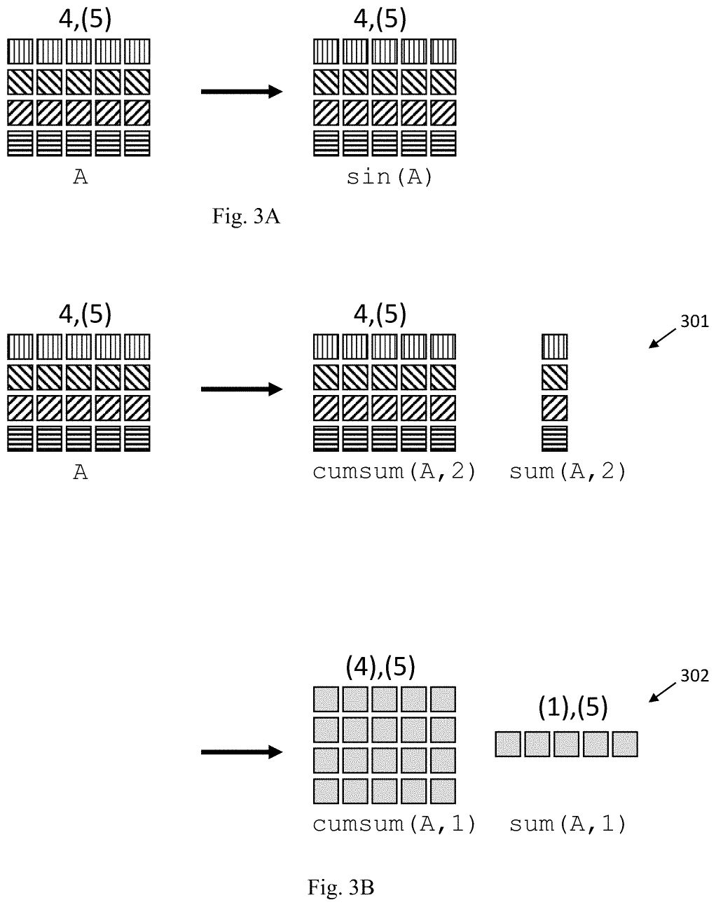

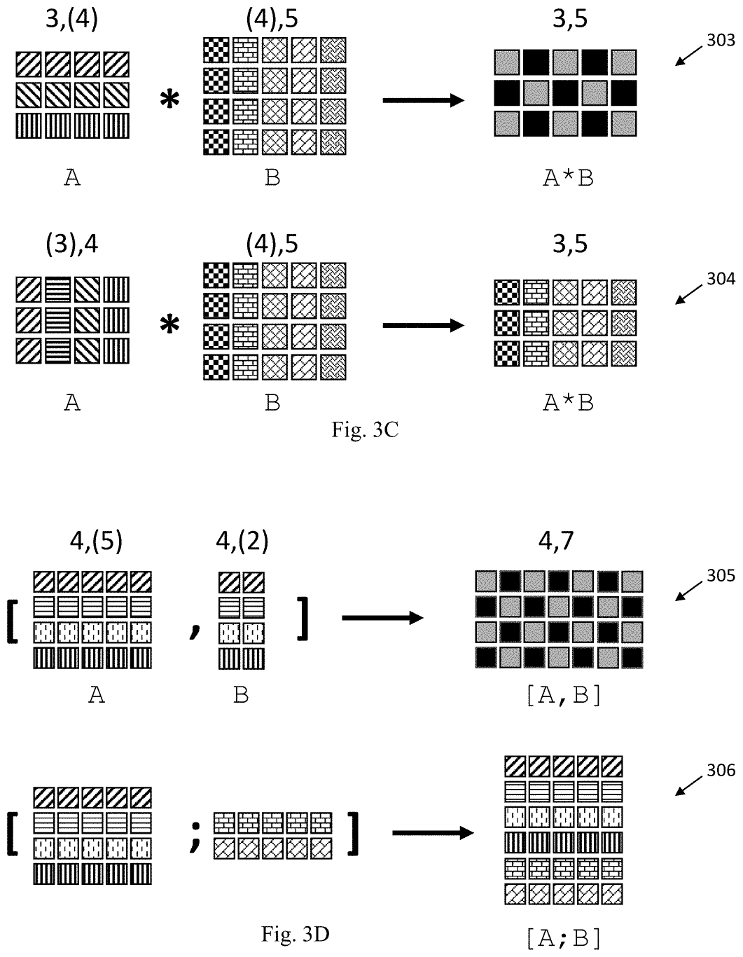

A few examples for how diverged/converged status of the inputs affect the diverged/converged status of the output of objects are demonstrated in FIGS. 3A-3D to which a reference is now made. FIG. 3A demonstrates objects that implement element-by-element functions (e.g., sin, cos, log, etc), which mirrors the divergence of their sources, for example by the function ‘sin’. FIG. 3B demonstrates dimension-wise functions (like, sum, cumsum, mean, any, etc.) which converge the specific dimensions of their input along the dimension on which they operate and maintain the converged/diverged status of other dimensions. In this example summation across converged dimensions (301), or across diverged dimensions (302), respectively. FIG. 3C demonstrates matrix multiplication in which C=A*B. The output C is diverged in the 1^{st} dimensions (rows) if A is diverged in the rows, and is diverged in the 2^{nd} dimension (columns) if B is diverged in the columns. The example of FIG. 3C depicts divergence status of a matrix multiplication when A is diverged across the rows and B is diverged across the columns (303), or when both A and B are diverged across the columns (304). FIG. 3D demonstrates concatenation functions that are diverged in the concatenating dimension and maintain converged/diverged status of their inputs in other dimensions. Thus, FIG. 3D depicts an example of divergence status of functional-objects that horizontally concatenate two input arrays which are both diverged across the rows (305), or that vertically concatenate two input arrays that are both diverged across the rows (306).

In some embodiments, the present disclosure provides overloading all (or any) graphics functions, such that applying a graphic function on an object yields a new object that performs the graphic operation. This behavior may generate bidirectionally “live” graphics: when the user makes a change to an upstream parameter, it may automatically propagate through the network and refresh the graphics, and when the user changes a graphic object (for example by dragging a slider made in a Man-Machine Interface (MMI) for enabling a user to change a value), this change may be interpreted as an assignment to the network object that implements the graphics. This functionality allows GUI-based human interventions to be implemented and recorded as object assignments (see above). Such GUI based assignments into objects are particular powerful when combined with “inverse assignment” (as explained in detail below).

In some embodiments, the user can trace the network upstream or downstream from any focal chosen object. Trace allows revealing all the raw data sources and manual assignments that affect each object and, vice versa, to trace all the results that are affected by a focal data source or a manual assignment. These trace results can be presented as a directed graph.

In some embodiments, a given functional object can represent within it a network of objects, recursively. The present disclosure provides for implementing such functional objects by functions that act directly on objects (rather than on the output of objects) and yields a new object.

In some embodiments, when an object output is a file name, it is interpreted as representing the file content. The object may track changes to the file content or meta-data and may trigger a downstream “change cascade” upon file change. This functionality allows live tracking of change in data files.

In some embodiments, long calculations can be cached not only as a memory cache but also as files. Such cache files can be named and accessed based on a Blockchain hash: The cache output file of each sub-object is assigned a hash sequence that represents any internal inputs to the object as well as the hashes of all source sub-objects (recursively). When a functional object is requested to perform long calculations, it first composes the hash and looks for the corresponding cache file. If such file exists, the result stored in the cache file is retrieved and the calculation is thereby avoided.

In some embodiments, each object is automatically named based on its function and sources. These names can be overridden by the user. For example, if S is an object with assigned name “Data”, then S2=sin(S) generates an object with a name “sin(Data)”.

In some embodiments, the present disclosure provides for an ‘inverse assignment’ functionality.

In inverse assignment, when a user overrides the output value to an object, either programmatically or through interactions with graphics or files, these assignments to the object are automatically translated into assignments to its upstream objects, recursively. Such inverse assignments of the data reverse any invertible operations. Inverse assignment may be applied in one of few different ways.

Let object B implement a certain internal function f_{B} of the output of object A. When a new output data-object b₀ is assigned (enforced) as the output of B, the object B may either override its current output with the newly supplied data-object b₀, or invert this assignment by applying the inverse function ƒ_{B}⁻¹ to the array b₀, obtaining a₀=ƒ_{B}⁻¹(b0) and then assigning this new value a₀ to its source object A. This inverse assignment can keep propagate upstream to the inputs of A if any, recursively.

The inversion of the internal function of each object may be done in one of three ways: (1) using a pre-compiled list designating for each arithmetic function its corresponding inverse function (sin→a sin, log→exp, etc); (2) using analytic solvers; and (3) using numeric goal-seeking solvers, for example, steepest descent.

When there are several solutions for an input producing the output (for example, for periodical functions like sin), the object may either automatically choose a solution, typically the one closest to the current output its upstream object A, or may offer the user to choose among the different possible solutions.

When the function involves multiple inputs, the assignment can be flown (i.e. propagated) upstream into either one of the inputs. For example, if A and B are objects and C is an object implementing A+B, then assigning c₀ into C (C←c₀) can be translated backwards in two different ways: either assigning c₀-B₀ into A (A←c₀-B₀), where B₀ is the current output of object B, or assigning c₀-A₀ into B (B←c₀-A₀), where A₀ is the current output of object A. The choice among these options is either done automatically (for example by using the first input as a convention), or is done by prompting the user for choice.

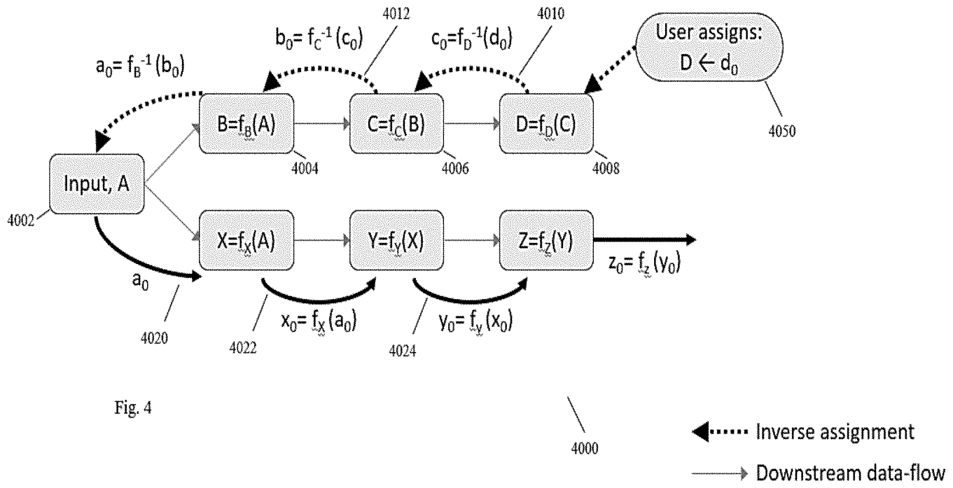

Reference is made now to FIG. 4, which is a schematic representation of general graph 4000, illustrating Inverse Assignment in a multi-level, multi branches network for a whole array, according to embodiments of the present invention. Objects (rectangles) are connected in a computational dataflow dependencies network (solid left-to-right arrows, downstream), starting with a source object A (4002) and transforming the data along two branches, one comprising the functional objects B, C and D, and the other comprising the functional objects X Y and Z. When a user assigns a value to one of the functional objects, the assignment may automatically be channeled (or propagated) backwards (or upstream) (represented by dashed arrows), reversing any invertible function. In here, the assignment of the value D₀ to the output of D (block 4050) is propagated backwards recursively all the way to a change in the source object A (block 4002). This change to the value of A (block 4002) is then propagated forward to affect B (block 4004), C (block 4006) and D (block 4008) (leading to D assuming the required output value D₀), as well as affecting any other objects that depend on A, in this case X (block 4020), Y (block 4022) and Z (block 4024).

This inverse assignment functionality allows for any given object X to be represented in multiple different forms, ƒ1(X), ƒ2(X), ƒ3(X), etc, where changes to any of these forms may automatically be translated, through inverse assignment, to changes to X and thereby to changes in all other forms. For example, these different forms could stand for different graphic representations of the same data. Changes to any of these forms, for example to ƒ1(X), may automatically be translated, by inverse assignments, to changes in the source data X and thereby automatically affect all other graphic forms of X, i.e., ƒ2(X), ƒ3(X), etc.

Let functional object B implement a certain function that operates independently on all or specific elements of the output array of its argument object A (for example, A is an object whose output is a matrix of numeric values and B applied the function ƒ_{B}(x)=2x to each of the elements of A, yielding a new array of the same size). When the user assigns a value into a specific element, or elements, of B (for example, assigning 8 into the matrix element 3 by 2, B(3,2)=8), the assignment may be propagated upstream and may be translated to an assignment into the specific elements of A that affect B at this data-element position (in this example, the assignment into B is inverted to assigning into A: A(3,2)=ƒ_{B}⁻¹(8)=8/2=4). This element-specific assignment then may keep propagating upstream, recursively.

As is the case for whole-array inverse assignments, element-specific inverse assignment requires inverting the internal-function of the object (see above for three ways in which function inversion may be done). Yet, in addition to inverting the function, element-specific inverse assignment also needs to invert the indices (array position) into which assignment is being made. Making such element-specific inverse assignment may involve generating a ‘wiring-map’ which describes the connection of each data-element of an object output to the specific elements of its input(s), that affect this focal output data-element. In the example above, the wiring-map trivially connects each array element (i,j) of B to its matching element (i,j) of A. More complex wire-maps may be implemented for other functions/operations. Here are just a few examples: (a) transpose: if B is the transpose of A, then assigning into element (i,j) of B is inverted as assignment into element (j,i) of A; (b) concatenation: if B implements concatenating two (or more) objects, say horizontally concatenating two row vectors X and Y, B=[X,Y], then assigning into B(i) is translated as assignment into X(i) for i<=length(X), and as assignment into Y(i-length(X)) for i>length(X); (c) array referencing: when B implements referencing specific array elements of an input A, assignment into B is implemented as assignment into the specific array elements that B refers to. For example, if B=A(3:8) (Matlab syntax as an example for referencing elements 3 to 8 of array A), then assigning into array position 4 of B is translated as assignment into array position 6 of A.

Inverse assignments can propagate reclusively to several upstream objects. For example, suppose A is an object representing the input array [1,2,3], B is defined as B=2*A, C is defined as C=B(2:3)+10, and D is defined as a horizontal concatenation operation D=[C, C] (Matlab syntax as an example). According to some embodiments, a user may intervene by assigning D the value D(4)=d₀, which may automatically be translated, by inverse assignment, into the following options:
D(4)=36 (direct), or
C(2)=36 (one level inverse), or
B(3)=26 (two-level inverse), or
A(3)=13 (three-level inverse).
   The choice among these options is either done automatically or is indicated by the user.

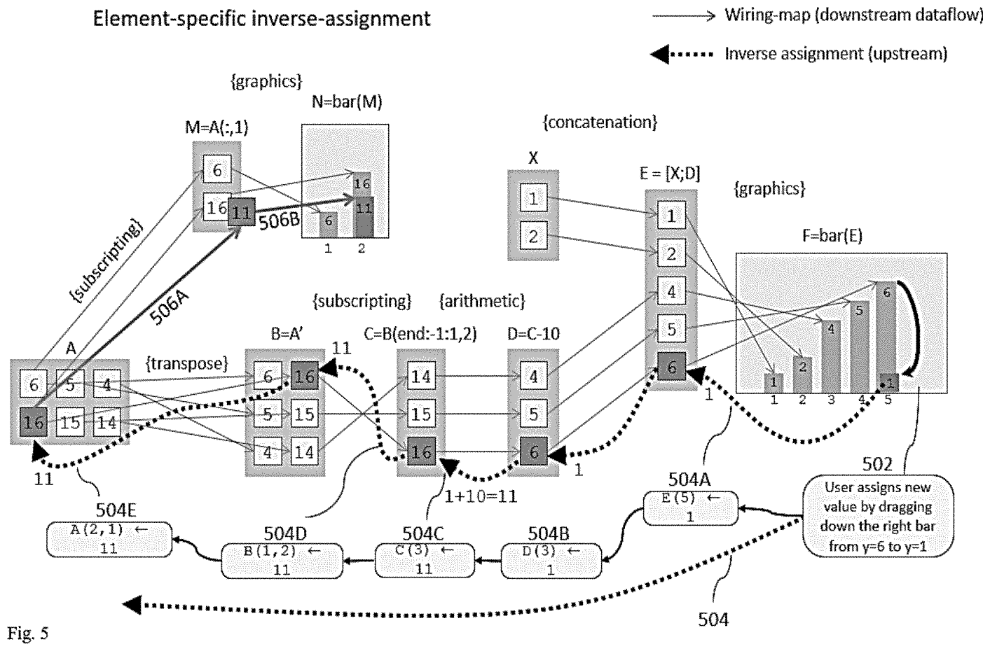

As an illustrating example of inverse assignment, consider the following code (Matlab syntax):
A=[6 5 4 16 15 14]
X=[1;2]
B=A′
C=B(end:−1:1,2)
D=C−10
E=[X;D]
F=bar (E)
M=A(:,1)
N=bar (M)
   This code can be translated into a network of connected objects where data is flowing downstream (left to right) as demonstrated in FIG. 5, which is a graphical representation of an implementation of inverse assignment, according to some embodiments of the present invention. In the graph of FIG. 5, the solid line arrows form the “wiring map”—connecting each data-element of an object output to the specific data elements of its inputs that affect this focal data element. In this example, A is a source-object representing a numeric array of size 2×3, B is a functional object performing the transpose of A (size 3×2), C is a functional object extracting the second column of B (size 3×1), D is a functional object subtracting 10 from the output of C, and E is functional object that vertically concatenates D with another array X. Finally, F is a functional object that implements the graphical “bar” function on the output of E, resulting in the depicted bar chart (graphic commands are also overloaded to work with the objects). In another parallel branch, M is a functional object extracting the left column of A, and N is a functional object whose output is a bar graph of M. Upon demand to refresh, an object with invalidated cache (say the graphic object F) request its input objects for their outputs and then performs its function, recursively. Requests for outputs are therefore flowing upstream and the output data is then flowing downstream.

One application of inverse assignments, according to some embodiments of the current invention, is that it allows to readily connect among different presentations of the same data. In the example of FIG. 5, E(5) and M(2) are a result of different transformations on the same numeric value A(2,1). Through backward assignment, an assignment changing E(5) by a user also changes M(2) and an assignment changing M(2) will, in a similar way, also change E(5) (because both of these assignments are propagated backwards (upstream) to an assignment into A(2,1)). For example, by changing the graphical representation of E(5) in the bar graph F, as depicted by arrow 502, a downstream cascade of inverse assignments will be triggered (as depicted by dashed-line arrow 504 and its recursive steps depicted by dashed-line arrows 504A-504E). In particular, assigning value of 1 to E at position 5 (E(5)←1) is inverted to assigning 1 to D at position 3 (D(3)←1) and then inverting the +10 function it translates to assigning 11 to C at position 3 (C(3)←11) and then to (B(1,2)←1) and then, inverting the transpose, it ultimately translates to A(2,1)←11. As a result of the inverse assignment into A(2,1), a downstream flow will cascade invalidating downstream objects at respective positions. Re-running the function will calculate the new values only in the respective positions, instead of recalculating the entire amount of data. This will update B, C, D, E and then the graphics F. It will also affect the other branch, changing M(2) from 16 to 11 and then the graphics N whose right bar will now change from 16 to 11. Thus, the wiring-map allows to propagate inverse assignments to the specific array indicates (or more generally data elements). Once an assignment is being made, the wiring map allows also to specifically invalidate only the affected data elements of downstream objects thereby much accelerating heavy re-computations upon input changes.

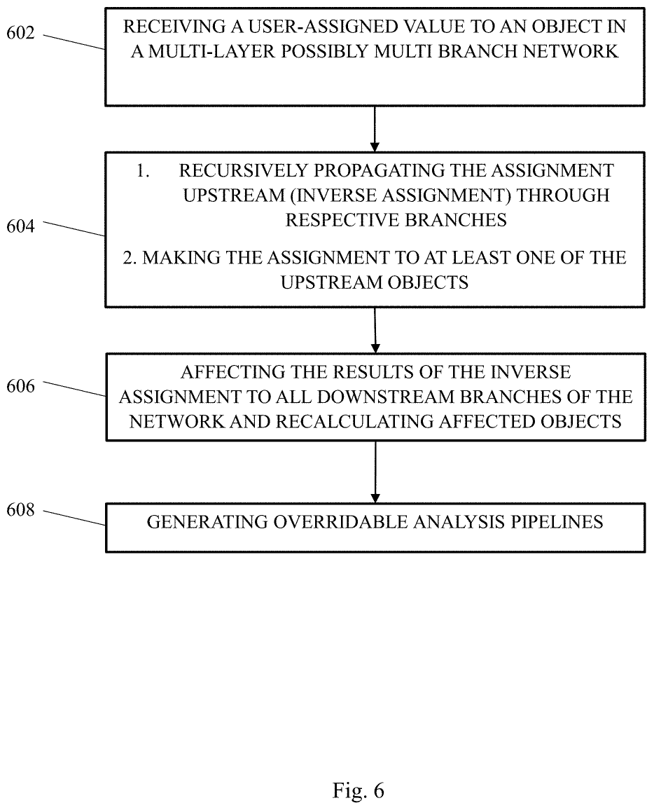

Reference is made now to FIG. 6, which is a schematic flow diagram depicting a method of affecting a user assigned value to an object in a multi-layer, multi-branch network according to embodiments of the present invention. A user assigned value may be received by the network (block 602). The user assigned value may recursively be propagated upstream the network in an inverse assignment process through respective branches and respective positions in data objects, and the upstream assignment may be marked to at least one upstream object (block 604). The results of the inverse assignment may be affected to all downstream branches of the network the affected objects may be calculated accordingly (block 606). Finally, analysis pipelines reflecting the effect of the user's override value may be generated (block 608).

The mechanism of inverse assignment allows, as described in detail, efficient, dynamic and virtually real-time affecting assignments imposed on a computational network, whether by the computing system or by a user, to propagate the assignment upstream through the associated positions only and then to propagate the change downstream to the associated positions only, thereby saving computing resources, shortening computing time and reducing memory/storage space associated with the re-running the network. Run-time may be improved because upon parameter changes only downstream calculations need to be repeated and within these downstream calculations only the ones pertaining to the specific affected data elements are the ones their calculation is repeated. Memory may be saved because for each object the system may decide whether or not to cache it. For object that performs a fast function its data will typically not be cached thereby saving memory. The disclosed embodiments of the current invention may be used in decision support systems e.g., in medicine development and may also be used for efficiently testing variations of engineering models that require running heavy simulation models with different selectable parameters.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

What is claimed is:

1. A method of generating data analysis pipelines in a network of a plurality of objects, wherein each object represents one of a functional object adapted to produce an output data object by performing transformation of its inputs, the method comprising:
receiving, via a user interface, an intervening input overriding at least one from a list comprising existing data object and the output data object of any of the functional objects;
recursively propagating the intervening input to upstream objects by inverting functions of functional objects; and
propagating the intervening overriding downstream to dependent objects to indicate which downstream functional transformations are invalidated by the overriding input.

2. The method of claim 1, wherein the input data object to each functional object is one or more from a list comprising files, numerical input data, and output data objects of one or more upstream functional objects of the plurality of objects in the network.

3. The method of claim 1, wherein the inverting of functional object is done by one or more of automatically choosing which upstream object to override and manually choosing which upstream object to override.

4. The method of claim 1 further comprising a step of recalculating the downstream functional transformations that were indicated invalid.

5. The method of claim 1, wherein the inverting of the object functions is done by connecting specific sub-elements of an output data object with corresponding specific sub-elements of its respective input data objects.

6. A computing device comprising:
a controller;
a memory unit;
a storage unit;
an input unit; and
an output unit;
wherein, the storage unit comprises executable code that when loaded to the memory unit and executed by the controller, is configured to perform:
receiving, via a user interface, an intervening input overriding at least one from a list comprising existing input data object and the output data object of any of the functional objects;
recursively propagating, by the controller, the intervening input to upstream objects by inverting functions of functional objects; and
propagating, by the controller, the intervening overriding downstream to dependent objects to indicate which downstream functional transformations are invalidated by the overriding input.

7. The computing device of claim 6, wherein the input data object to each functional object is one or more from a list comprising files, numerical inputs data objects, and output data objects of one or more upstream objects of the plurality of objects in the network.

8. The computing device of claim 6, wherein the inverting of the functions of functional objects is done by connecting specific sub-elements of an output data object with corresponding specific sub-elements of its respective input data objects.

9. The computing device of claim 6 further comprising recalculating the downstream functional transformations that were indicated invalid.

10. The computing device of claim 6, wherein the inverting of the object functions is done by connecting specific sub-elements of an output data object with corresponding specific sub-elements of its respective input data objects.

11. A method of generating analysis pipelines in a network of a plurality of objects, wherein each object represents one of a functional object adapted to perform transformation of its inputs or an output data object produced by the functional transformation, the method comprising:
receiving, via a user interface, an intervening input overriding a subset of the data elements of the output data object of any of the functional objects;
recursively propagating, by the controller, the intervening input upstream to respective subset of data objects by inverting functions of functional objects; and
propagating the intervening overriding downstream to dependent objects to indicate which downstream subsets of data elements of data objects are invalidated by the overriding input.

12. The method of claim 11, wherein the input data object to each functional object is one or more from a list comprising files, numerical input data objects, and output data objects of one or more upstream objects of the plurality of objects in the network.

13. The method of claim 11, wherein the inverting of functional objects is done by one or more of automatically choosing which upstream object to override and manually choosing which upstream object to override.

14. The method of claim 11 further comprising a step of recalculating the downstream functional transformations of the subsets of data elements of data objects that were indicated invalid.

15. The method of claim 11, wherein the inverting of the object functions is done by connecting specific sub-elements of an output data object with corresponding specific sub-elements of the respective input data object.
